(19) United States
(12) Patent Application Publication
(10) Pub. No.: US 2008/0005849 A1
(43) Pub. Date: Jan. 10, 2008

(54) Method of making genuine leather

(75) Inventors: Jung Gyun Noh, Gyeonnggi-do (KR); Sae Dong Jang, Chungcheongbuk-do (KR); Kieyoun Jeong, Gyeonggi-do (KR); Jin Pyo Hong, Chungcheongbuk-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Cho Kwang Leather Co., Ltd., Chungcheongbuk-do (KR)

(21) Appl. No.: 11/637,465

(22) Filed: Dec. 11, 2006

(30) Foreign Application Priority Data
Jul. 7, 2006 (KR) 10-2006-0064038

(51) Int. Cl. C14C 1/00

(52) U.S. Cl. 8/94.15; 8/115.51

(57) ABSTRACT

The present invention relates to a method of manufacturing a genuine leather comprising the steps of Beamhouse, tanning, dyeing, drying and Finishing, wherein anion-emitting material is used in the Finishing step.

### CROSS-REFERENCE TO RELATED APPLICATIONS

This application claims priority from Korean Patent Application No. 10-2006-0064038 filed on Jul. 7, 2006 with the Korean Intellectual Property Office, the disclosure of which is incorporated herein by reference.

### FIELD OF THE INVENTION

The present invention relates to a method of making a genuine leather, and more particularly, to a method of preparing a genuine leather that can enhance physiological metabolism and stimulate fatigue release of end users.

### BACKGROUND

Leather goods are largely classified into genuine leathers and artificial leathers. With soft touch, high quality and excellent durability, genuine leathers are preferred to artificial leathers, although they are expensive and limited in quantity.

To obtain quantity of genuine leathers from animals, complicated processing procedures are required. As a result, genuine leathers tend to be expensive despite that they retain offensive smell on the surface due to numerous chemicals used in the processing procedures.

Conventional genuine leathers, however, have not been designed to enhance immune system and physiological metabolism of human body and to stimulate fatigue relief.

Thus, the object of the present invention is to provide a method for manufacturing genuine leathers that can enhance immune system and physiological metabolism of human body and stimulate fatigue relief.

### SUMMARY OF THE INVENTION

In one aspect, the present invention provides a method of manufacturing a genuine leather comprising the steps of Beamhouse, tanning, dyeing, drying and Finishing, wherein anion-emitting material is used in the Finishing step.

Preferably, the Finishing step may comprise the sub-steps of flesh side coating, sealing coating, base coating, color coating and top coating.

In a preferred embodiment, anion-emitting material may be used in the flesh side coating step, the base coating step, or both steps.

A suitable amount of anion-emitting material is 10 to 20 parts by weight per 100 parts by weight of the flesh side coating composition. Another suitable amount of anion-emitting material is 15 to 25 parts by weight per 100 parts by weight of the base coating composition.

In a preferred embodiment, anion-emitting material may be used in an amount of 10 to 20 parts by weight per 100 parts by weight of the flesh side coating composition in the back coating step and in an amount of 15 to 25 parts by weight per 100 parts by weight of the base coating composition in the base coating steps.

A preferable particle size of the anion-emitting material used in the flesh side coating step and the base coating step is 0.7 to 50 μm.

A suitable anion-emitting material includes, but not limited to, fine charcoal, cloisonné and a mixture thereof.

In another aspect, genuine leathers are provided which are manufactured by a described method. Also provided are motor vehicles comprising such genuine leathers.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present method and genuine leathers prepared by the method will be particularly useful with a wide variety of motor vehicles.

Other aspects of the invention are discussed infra.

### DETAILED DESCRIPTION

Reference will now be made in detail to the preferred embodiment of the present invention. The embodiments are described below so as to explain and illustrate the present invention.

As discussed above, the present invention provides a method of manufacturing a genuine leather comprising the steps of Beamhouse, tanning, dyeing, drying and Finishing, wherein anion-emitting material is used in the Finishing step.

A process of manufacturing genuine leathers comprises the steps of Beamhouse, tanning, dyeing, drying and Finishing, each of which will be described below in detail.

The Beamhouse step comprises the sub-steps of soaking, liming and fleshing.

Soaking process removes impurities or water-soluble proteins by replenishing moisture to the salted rawhide. Liming process removes hairs, keratin or other unwanted proteins and relaxing fibrous tissues through alkalization. Fleshing process removes flesh side fats and unfolds the wrinkles of the rawhide.

In the tanning step, heat resistance and flexibility are conferred to the leather through addition of mineral substances, for commercialization of leather

The dyeing step comprises the sub-steps of retanning, neutralization and fatliquoring.

In the retanning sub-step, a polymer or other materials at the belly part of the rawhide is used to reduce the friction between fibers and improve flexibility, elasticity, fullness of the leather, etc., as the organization of soft fibers at the belly part of rawhide is comparatively loose and it is difficult to obtain thin leather with good fullness from chromium tanning only.

In the fatliquoring sub-step, dye matching is conducted to improve softness and elasticity.

The drying step is carried out to unfold wrinkles and maintain constant moisture.

The Finishing step is carried out in order to cover natural defects from the surface of the leather. The step comprises the following sub-steps: flesh side coating, sealing coating, base coating, color coating and top coating. In a preferred embodiment of the present invention, 10 to 20 parts by weight of an anion-emitting material having a particle size in the range between 0.7 and 50 μm may be coated, per 100 parts by weight of the flesh side coating composition, as a mixture with binder, auxiliary, etc., in the sub-step of the flesh side coating. An amount less than 10 parts by weight may produce less anions. On the other hand, an amount more than 20 parts by weight may cause the coating film to be thick, thereby reducing the adhesiveness or impairing other physical properties, e.g., worsening the texture of the genuine leather.

Preferably, in the base coating sub-step, 15 to 25 parts by weight of an anion-emitting material having a particle size in the range between 0.7 and 50 μm may be coated, per 100 parts by weight of the base coating composition, as a mixture with pigment, binder, auxiliary, etc. An amount less than 15 parts by weight may produce less anions. On the other hand, an amount more than 25 parts by weight may cause the coating film to be thick, thereby reducing the adhesiveness or impairing other physical properties, e.g., worsening the texture of the genuine leather.

A preferred example of anion-emitting material includes, but not limited to, fine charcoal, cloisonné and a mixture thereof. Fine charcoal can be obtained by burning oak at 1,000° C. or above, and it is composed of 90% carbon, 9% water and trace of ash content. Charcoal is weakly alkaline with pH 8-9 and is porous with an internal area of approximately 300 m² per 1 g. It further contains about 230 or more kinds of minerals. Fine charcoal serves to purify air through anion emission, promote the metabolism of the human body through far infrared radiation and absorb odor and moisture by its porosity. Moreover, it offers superior preservation and filtering properties.

Cloisonné is an ore with more than seven colors, which emits energy 250 times stronger than that of jade. It also emits 36 kinds of characteristic energies and is composed of granites, schist, gneisses, limestone, quartzite, shale, and andesite, etc.

Anion-emitting material with a particle size of less than 0.7 μm may increase the price of the final product. In contrast, anion-emitting material with a particle size of more than 50 μm can reduce the adhesiveness of the final product and cause a rough and hard surface of the coated surface, which in turn can impair the texture properties of genuine leathers.

Table 1 below enlists the materials used in each sub-step of the Finishing step in accordance with a preferred embodiment of the present invention. The contents represented by percentages based on the weight of the Finishing composition after drying procedure.

TABLE 1

| | | Fesh side | Sealing | Base | Color | Top |
|---|---|---|---|---|---|---|
| Classification | | coating | coating | coating | coating | coating |
| Pigment | | — | — | 10 to 30 | 15 to 30 | — |
| Binder | Urethane | 5–10 | 5–15 | 15–25 | 15–25 | 5–15 |
| | Acryl | 20–50 | 15–30 | 15–25 | 15–25 | 5–15 |
| Auxiliary | | 5–15 | 10–20 | 10–15 | 5–15 | 25–55 |
| Anion- | Fine | 10–20 | — | 15–25 | — | — |
| emitting | charcoal | | | | | |
| material | composition | | | | | |
| X-linker | Isocyanate | — | — | — | — | 10–15 |
| | Epoxy | — | — | — | — | 10–15 |

| | | | | | |
|---|---|---|---|---|---|
| Water | 30–40 | 40–70 | 5–15 | 20–40 | 15–20 |

In Table 1, the pigment may include, but not limited to, any one commonly used in the related field, although resin, melamine, polyurethane, protein, etc., is preferably used.

Preferred embodiments of the present invention are illustrated as shown in the following examples. However, it will be appreciated that those skilled in the art may, in consideration of this disclosure, make modifications and improvements within the spirit and scope of the present invention.

### EXAMPLE 1

A sample of genuine leather according to a preferred embodiment of the present invention was prepared by coating 100 parts by weight of Finishing composition that passed through the steps of Beamhouse, tanning, dyeing and drying. The Finishing composition is shown in Table 2 below.

TABLE 2

| Classification | | Flesh side coating | Base coating |
|---|---|---|---|
| Pigment | Pigment | — | 20 |
| Binder | Urethane | 10 | 25 |
| | Acryl | 20 | 15 |
| Auxiliary | Filler | 10 | 15 |
| Anion-emitting | Fine charcoal | 15 | 20 |
| material | composition | | |
| X-linker | Isocyanate | — | — |
| | Epoxy | — | — |

| | | |
|---|---|---|
| Water | 35 | 10 |

### COMPARATIVE EXAMPLE 1

A comparative sample of genuine leather was prepared in the same manner as in Example 1, except the anion-emitting materials are not used. The Finishing composition is shown in Table 3 below.

TABLE 3

| | | |
|---|---|---|
| Classification | Flesh side coating | Base coating |

| | | | |
|---|---|---|---|
| Pigment | Pigment | — | 20 |
| Binder | Urethane | 10 | 25 |
| | Acryl | 20 | 15 |
| Auxiliary | Filler | 10 | 15 |
| X-linker | Isocyanate | — | — |
| | Epoxy | — | — |

| | | |
|---|---|---|
| Water | 35 | 10 |

### TEST EXAMPLE

Anion emission was measured under the condition of room temperature of 21-25° C., humidity of 45-55% RH, and anion counts in air of 30-100. The result is given in Table 4 below.

TABLE 4

| Classification | Example 1 | Comparative Example 1 |
|---|---|---|
| Anion counts | 455 | 77 |

As shown in Table 4, the leather prepared by using the composition comprising the anion-emitting material showed a significantly larger anion counts, compared to the leather prepared by a conventional Finishing method.

As apparent from the above description, the genuine leather prepared in accordance with the present invention using anion-emitting material such as fine charcoal and cloisonné shows significant increase in anion emission. It can also increase the value added to the products by enhancing immune system and physiological metabolism of human body and stimulating fatigue relief.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of manufacturing a genuine leather comprising the steps of Beamhouse, tanning, dyeing, drying and Finishing, wherein anion-emitting material is used in the coating step.

2. The method of manufacturing a genuine leather of claim 1, wherein the Finishing step comprises the sub-steps of flesh side coating, sealing coating, base coating, color coating and top coating.

3. The method of manufacturing a genuine leather of claim 2, wherein the anion-emitting material is used in the back side coating step, the base coating step, or both steps.

4. The method of manufacturing a genuine leather of claim 3, wherein the anion-emitting material is used in an amount of 10 to 20 parts by weight per 100 parts by weight of the flesh side coating composition.

5. The method of manufacturing a genuine leather of claim 3, wherein the anion-emitting material is used in an amount of 15 to 25 parts by weight per 100 parts by weight of the base coating composition.

6. The method of manufacturing a genuine leather of claim 3, wherein the anion-emitting material is used in an amount of 10 to 20 parts by weight per 100 parts by weight of the flesh side coating composition in the flesh side coating step and in an amount of 15 to 25 parts by weight per 100 parts by weight of base coating composition in the base coating step.

7. The method of manufacturing a genuine leather of claim 6, wherein the anion-emitting material used in the flesh side coating step and the base coating step has a particle size of 0.7 to 50 μm.

8. The method of making genuine leather of claim 1, wherein the anion-emitting material is selected from the group consisting of fine charcoal, cloisonné and a mixture thereof.

9. A genuine leather manufactured by the method of claim 1.

10. A motor vehicle comprising the genuine leather of claim 9.
